(19) United States
(12) Patent Application Publication
(10) Pub. No.: US 2026/0358169 A1
(43) Pub. Date: Nov. 12, 2026

(54) Weight Scale Calibration and Methods of Operating a Weight Scale

(71) Applicant: Acaia Corporation, Alhambra, CA (US)

(72) Inventors: Rex Poway Tseng, Taipei (TW); Chien-Chun Han, Taipei (TW)

(21) Appl. No.: 19/670,699

(22) Filed: May 7, 2026

Related U.S. Application Data
(60) Provisional application No. 63/802,956, filed on May 9, 2025.

(51) Int. Cl. G01G 23/18; A47J 31/44; G01G 21/22; G01G 23/01

(52) U.S. Cl. CPC G01G 23/18; A47J 31/44; G01G 21/22; G01G 23/01

(57) ABSTRACT

A secondary scale includes a platter, a load sensor, an electronic display, and a controller. The load sensor is mounted below the platter in mechanical connection therewith to detect a mass of the scale load. The controller is configured to perform operations including receiving a measured reference-scale (RS) weight value (W_{A1}) and a raw RS weight value (ADC_{A1}) corresponding to a first static object, determining a raw secondary-scale (SS) weight value (ADC_{B1}) of the first static object, receiving a measured RS weight value (W_{A2}) and a raw RS weight value (ADC_{A2}) corresponding to a second static object, determining a raw SS weight value (ADC_{B2}) of the second static object at the secondary scale, and defining a calibration factor, defining a calibration factor comprising determining a reference-correction factor based on the measured RS weight values (W_{A1}, W_{A2}), raw RS weight values (ADC_{A1}, ADC_{A2}), and raw SS weight values (ADC_{B1}, ADC_{B2}).

### PRIORITY STATEMENT

The present application claims the benefit of priority to U.S. Provisional Patent Application Serial No. 63/802,956, filed on May 9, 2025, the disclosure of which is incorporated by reference herein in its entirety.

### FIELD OF THE DISCLOSURE

The present subject matter relates generally to weighing devices or scales, and more particularly to coffee scales, including methods of operating the same.

### BACKGROUND OF THE DISCLOSURE

Coffee, in its many forms and according to numerous brewing methods, is one of the most popular beverages throughout the world. Typical brewing methods broadly include immersion and percolation. In either case, coffee beans are ground into a powder (i.e., coffee grounds) before being introduced to water in order to extract various chemical compounds and flavors to create a coffee beverage.

Generally, the flavor and texture of a coffee beverage will be influenced or affected by both the mass ratio of coffee grounds to water, as well as the time in which a specific mass of water interacts (e.g., steeps, mixes, or strains through) the coffee grounds. As a result, an accurate coffee scale may be useful to measure coffee beans/grounds and water. Accuracy of such a scale may be especially important to maintaining consistency or quality of a resulting coffee beverage. In order to ensure scale accuracy, it may be necessary to calibrate the scale, even over time and after considerable use of the scale. Traditional calibration methods rely on certified standard calibration weights. These weights, typically made of stainless steel or other stable materials, are manufactured to strict tolerances and certified by metrology authorities. Unfortunately, such weights may be costly to obtain or difficult to manage (e.g., keep from being lost or damaged). Even if a single certified standard calibration weight is obtained and managed, however, the weight scale may still be inaccurate or uncalibrated for other (e.g., lower or higher) weights. This may be become particularly problematic if a user wishes to create a variety of different beverages or sizes.

Some self-calibrating scales exist to try to address some of the above issues. Such self-calibrating scales typically provide internal calibration weights built into the scale, including motorized systems for moving internal weights for automatic calibration. However, these scales are typically expensive or complicated to assemble and maintain. Moreover, they can lack durability or otherwise be suitable for coffee-making or culinary environments.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a method of operating a scale is provided. The method may include receiving a measured reference-scale (RS) weight value (W_{A1}) and a raw RS weight value (ADC_{A1}) corresponding to a first static object from a reference scale; determining a raw secondary-scale (SS) weight value (ADC_{B1}) of the first static object at a secondary scale; receiving a measured RS weight value (W_{A2}) and a raw RS weight value (ADC_{A2}) corresponding to a second static object from the secondary scale; determining a raw SS weight value (ADC_{B2}) of the second static object at the secondary scale; and defining a calibration factor, defining a calibration factor comprising determining a reference-correction factor based on the measured RS weight values (W_{A1}, W_{A2}), the raw RS weight values (ADC_{A1}, ADC_{A2}), and the raw SS weight values (ADC_{B1}, ADC_{B2}).

In another aspect of the present disclosure, a secondary scale is provided. The secondary scale may include a platter, a load sensor, an electronic display, and a controller. The platter may receive a scale load thereon. The load sensor may be mounted below the platter in mechanical connection therewith to detect a mass of the scale load. The electronic display may be attached to the platter. The controller may be operably connected to the load sensor and the electronic display. The controller may be configured to perform operations including receiving a measured reference-scale (RS) weight value (W_{A1}) and a raw RS weight value (ADC_{A1}) corresponding to a first static object from a reference scale, determining a raw secondary-scale (SS) weight value (ADC_{B1}) of the first static object at the secondary scale, receiving a measured RS weight value (W_{A2}) and a raw RS weight value (ADC_{A2}) corresponding to a second static object from the secondary scale, determining a raw SS weight value (ADC_{B2}) of the second static object at the secondary scale, and defining a calibration factor, defining a calibration factor comprising determining a reference-correction factor based on the measured RS weight values (W_{A1}, W_{A2}), the raw RS weight values (ADC_{A1}, ADC_{A2}), and the raw SS weight values (ADC_{B1}, ADC_{B2}).

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a plan view of a scale according to exemplary embodiments of the present disclosure.

FIG. 2 provides a schematic section view of the exemplary scale of FIG. 1.

FIG. 3 provides a schematic view of a set of connected scales.

FIG. 4 provides a flow chart illustrating a method of operating a scale according to exemplary embodiments of the present disclosure.

FIG. 5 provides a flow chart illustrating a method of operating a scale according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Aspects of the present disclosure may provide a scale (e.g., coffee scale) that can be calibrated using another scale to which it is connected (e.g., wirelessly or electrically connected to share data or signals therewith). In other words, a first scale can be calibrated using a second scale. Aspects of the present disclosure may advantageously avoid needing any certified standard calibration weights or secondary items having fixed properties over time. Additionally or alternatively, aspects of the present disclosure may make use of multiple common or indeterminate items to calibrate a scale across a variety of weights or ranges.

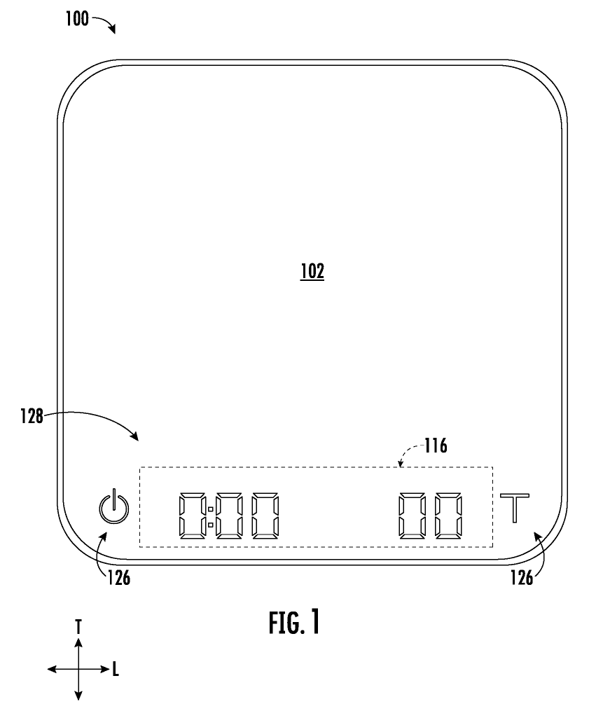

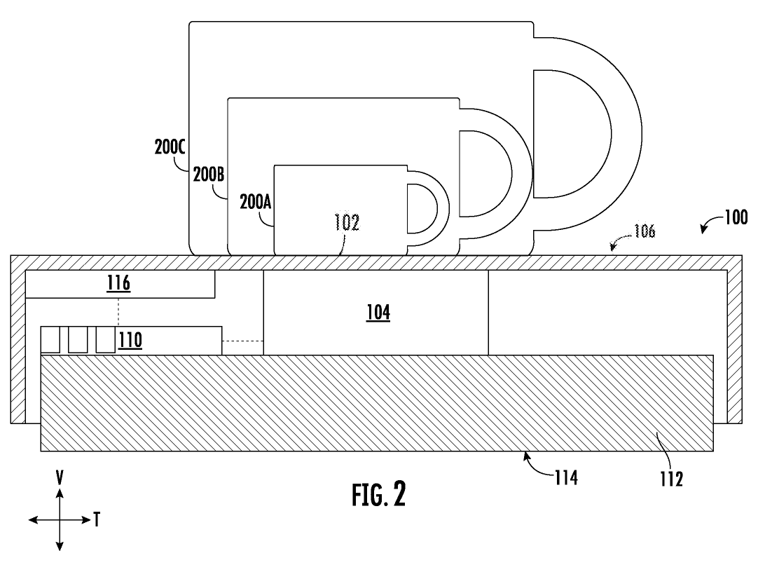

Turning now to the figures, FIGS. 1 and 2 provide views of a scale 100 (e.g., electronic coffee scale) according to exemplary embodiments of the present disclosure. Generally, scale 100 defines a mutually orthogonal vertical direction V, lateral direction L, and transverse direction T. Scale 100 may provide a platter 102 and a load sensor 104 to receive and detect the mass of a scale load (e.g., receptacle, cup, container, vessel, coffee beans, volume of liquid, food item, etc.). For instance, the platter 102 may be formed from one or more suitable materials (e.g., rigid metal or polymer) and define an upper receiving surface 106 onto which the scale load may be placed or supported. For instance, one or more static objects 200A, 200B, 200C having different masses or volumes may be received on the upper receiving surface 106 (e.g., at different moments or points in time). As an example, a first static object 200A having a first mass (e.g., a mass value in a range between 10 grams and 200 grams, such as might be used with a common espresso dose or espresso container) may be placed on or used with scale 100. As an additional or alternative example, a second static object 200B having a second mass (e.g., a mass value in a range between 200 grams and 800 grams, such as might be used with a common single-serve coffee dose or coffee container) may be placed on or used with scale 100. As another additional or alternative example, a third static object 200C having a third mass (e.g., a mass between 800 grams and 3000 grams, such as might be used with a common batch brewer dose or batch brewer). In some embodiments, the first static object 200A has a first mass, the second static object 200B has a second mass, the third static object 200C has a third mass, wherein the second mass is greater than the first mass, and wherein the third mass is greater than the second mass.

Below the upper receiving surface 106, the load sensor 104 may be mounted. Specifically, the load sensor 104 may be mounted in mechanical connection with the platter 102. During use, a force or moment generated by the weight of the scale load is transferred (at least in part) through the platter 102 to the load sensor 104. In turn, the load sensor 104 may be able to detect the mass of the scale load. Generally, load sensor 104 is provided as or includes any suitable electronic load sensor or cell (e.g., one or more electronic load sensors or cells) configured to generate one or more electronic signals according (e.g., in proportion to) a mass of a load thereon. For instance, load sensor 104 may include a suitable strain gauge, force sensitive resistor, capacitance sensor, hydraulic pressure sensor, or pneumatic pressure sensor—as would be understood. As will be described in greater detail below, the load sensor 104 may be in operable (e.g., wireless or electrical) communication with a controller 110 to which the generated electronic signals may be communicated.

In some embodiments, a base frame 112 is provided to support the platter 102 or load sensor 104. For instance, the base frame 112 may be disposed below one or both the platter 102 and load sensor 104. The base frame 112 may include or define a bottom base surface 114 that is directed downward to sit on or contact a support surface (e.g., countertop or other structure onto which the scale 100 is placed). The load sensor 104 may be sandwiched or disposed between at least a portion of the platter 102 (e.g., at the upper surface 106) and at least a portion of the base frame 112 (e.g., at the bottom base surface 114), such as relative to the vertical direction V. In some such embodiments, the platter 102 (e.g., at least portion thereof) “floats” or may otherwise be deflectable (e.g., along the vertical direction V) relative to the base frame 112. During use, reception of the scale load (e.g., 200A, 200B, or 200C) may thus act to push, bend, or deform the platter 102, which may in turn be transferred to the load sensor 104 to subsequently detect (or facilitate detection of) the mass of the scale load, as would be understood.

In certain embodiments, an electronic display 116 is provided with scale 100. In particular, the electronic display 116 may be attached (e.g., directly or, alternatively, indirectly) to the platter 102 or base frame 112. For instance, the electronic display 116 may be supported on the base frame 112. Optionally, the electronic display 116 be provided on or beneath at least a portion of the platter 102. In the illustrated embodiments, the electronic display 116 is supported on the platter 102 beneath the upper surface 106. As shown, the electronic display 116 may be directed (e.g., upward) through the platter 102 to project at least a portion of the display to the upper surface 106, such as in a dead front display. Generally, the electronic display 116 include or be provided as any suitable electrically activated display (e.g., in operable communication with the controller 110), such as a digital screen, electronic segment display, projector, liquid crystal display (LCD), vacuum fluorescent display (VFD), light emitting diode (LED), electroluminescent display (ELD), plasma display panel (PDP), cathode-ray tube (CRT), or laser-powered phosphor display (PLD).

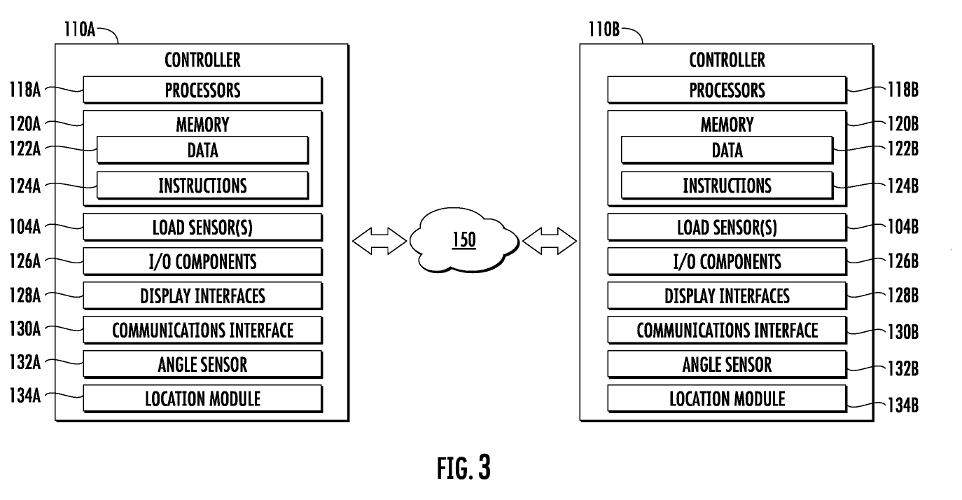

Turning now to FIG. 3, a plurality of calibration scales is illustrated. As would be understood, each of the calibration scales may include one or more features of, or be embodied as, scale 100 (FIGS. 1 and 2). As will be explained in greater detail below, the scales may include at least one reference scale 100A and at least one secondary scale 100B that may be (or has been) calibrated based, at least in part, on data generated at and received from the reference scale 100A.

At the reference scale 100A, a controller 110A may be attached (e.g., directly or, alternatively, indirectly) to a corresponding platter 102 or base frame 112 (FIGS. 1 and 2). The controller 110A includes one or more processors 118A and a memory 120A. The one or more processors 118A can be any suitable processing device (e.g., a processor core, a microprocessor, an ASIC, a FPGA, a microcontroller, etc.) and can be one processor or a plurality of processors that are operatively connected. The memory 120A can include one or more non-transitory computer-readable storage mediums, such as RAM, ROM, EEPROM, EPROM, flash memory devices, magnetic disks, etc., and combinations thereof. The memory 120A can store data 122A and instructions 124A which are executed by the processor 118A to cause the controller 110A to perform operations.

The controller 110A can also include one or more user input component 126A that receives user input. For example, the user input component 126A can be a touch-sensitive component (e.g., a touch-sensitive display screen or a touch pad) that is sensitive to the touch of a user input object (e.g., a finger or a stylus). The touch-sensitive component can optionally serve to implement a virtual keyboard. Other example user input components include a microphone, a tactile or physical button, a traditional keyboard, or other means by which a user can provide user input.

In some implementations, the controller 110A can store or provide one or more user interfaces 128A, such as the electronic display 116 (FIG. 1), which may be associated with one or more applications. The one or more user interfaces 128A can be configured to receive inputs or provide data for presentation or display (e.g., image data, text data, audio data, one or more user interface elements, an augmented-reality experience, a virtual reality experience, or other data for display). The user interfaces 128A may be associated with one or more other computing systems (e.g., a server computing system or third party computing system). The user interfaces 128A can include a viewfinder interface, a search interface, a generative model interface, a social media interface, or a media content gallery interface.

The controller 110A may include or receive data from one or more load sensors 104A. The one or more sensors 104A may be housed in a housing component that houses the one or more processors 118A, the memory 120A, or one or more hardware components, which may store, or cause to perform, one or more software packets.

It is noted that, although not pictured, a suitable power source (e.g., battery, AC voltage port, etc.) could be provided in electrical communication with reference scale 100A to electrically power the same (e.g., as is generally understood).

In some embodiments, controller 110A includes a communications interface 130A such that reference scale 100A can connect to and communicate over one or more networks (e.g., network 150) with one or more network nodes, such as secondary reference scale 100A. Communications interface 130A can be an onboard component of controller 110A or it can be a separate, off board component. In some implementations, the communications interface 130A may include for example, one or more of a communications controller, receiver, transceiver, transmitter, port, conductors, software and/or hardware for communicating data/information. Controller 110A can also include one or more transmitting, receiving, or transceiving components for transmitting/receiving communications with other devices communicatively coupled with reference scale 100A. Additionally or alternatively, one or more transmitting, receiving, or transceiving components can be located off board controller 110A.

Network 150 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 150 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In certain embodiments, controller 110A includes an angle sensor 132A that is generally configured to detect a plurality of angle readings. Angle sensor 132A can be an onboard component of controller 110A or it can be a separate, off board component (e.g., attached to a platter 102 or base frame 112 (FIGS. 1 and 2)). As would be understood, the angle sensor 132A may include a microprocessor that performs the calculations specific to the measurement of position or movement with the calculation results being used by controller 110A.

As noted above, angle sensor 132A may detect a plurality of angle readings. For instance, multiple angle readings may be detected simultaneously to track multiple (e.g., mutually orthogonal) axes of the reference scale 100A, such as an X-axis, Y-axis, and Z-axis. For instance, the axes may be detected or tracked relative to gravity. Optionally, an angle sensor 132A may be or include an accelerometer, which measures, at least in part, the effects of gravity (e.g., as an acceleration component), such as acceleration along one or more predetermined directions. Additionally or alternatively, an angle sensor 132A may be or include a gyroscope, which measures rotational positioning (e.g., as a rotation component).

An angle sensor 132A in accordance with the present disclosure can be mounted on or within the reference scale 100A, as required to sense movement or position of reference scale 100A relative to the gravity or a supporting surface. Optionally, angle sensor 132A may include at least one gyroscope or at least one accelerometer. The angle sensor 132A, for example, may be a printed circuit board which includes the gyroscope and accelerometer thereon.

In additional or alternative embodiments, the controller 110A includes location module 134A that is generally configured to detect a geographic location of reference scale 100A. Location module 134A can be an onboard component of controller 110A or it can be a separate, off board component (e.g., attached to a platter 102 or base frame 112 (FIGS. 1 and 2)). As one example, location module 134A can be a Global Positioning System (GPS) and can receive location or position information from a plurality of GPS satellites. In turn, location module 134A can include various hardware and software known in the art for receiving data indicative of a geographic location of reference scale 100A. For instance, location module 134A can include a GPS receiver. In some embodiments, location module 134A can automatically obtain data indicative of the geographic location of reference scale 100A when reference scale 100A is connected to network 150 (e.g., in response to the same). In other embodiments, location module 134A can obtain data indicative of the geographic location of reference scale 100A when reference scale 100A is connected to appliance network 150 and upon a user input.

Separate from or in addition to the reference scale 100A, at the secondary scale 100B, a controller 110B may be attached (e.g., directly or, alternatively, indirectly) to a corresponding platter 102 or base frame 112 (FIGS. 1 and 2). The controller 110B includes one or more processors 118B and a memory 120B. The one or more processors 118B can be any suitable processing device (e.g., a processor core, a microprocessor, an ASIC, a FPGA, a microcontroller, etc.) and can be one processor or a plurality of processors that are operatively connected. The memory 120B can include one or more non-transitory computer-readable storage mediums, such as RAM, ROM, EEPROM, EPROM, flash memory devices, magnetic disks, etc., and combinations thereof. The memory 120B can store data 122B and instructions 124B which are executed by the processor 118B to cause the controller 110B to perform operations.

The controller 110B can also include one or more user input component 126B that receives user input. For example, the user input component 126B can be a touch-sensitive component (e.g., a touch-sensitive display screen or a touch pad) that is sensitive to the touch of a user input object (e.g., a finger or a stylus). The touch-sensitive component can optionally serve to implement a virtual keyboard. Other example user input components include a microphone, a tactile or physical button, a traditional keyboard, or other means by which a user can provide user input.

In some implementations, the controller 110B can store or provide one or more user interfaces 128B, such as the electronic display 116 (FIG. 1), which may be associated with one or more applications. The one or more user interfaces 128B can be configured to receive inputs or provide data for presentation or display (e.g., image data, text data, audio data, one or more user interface elements, an augmented-reality experience, a virtual reality experience, or other data for display). The user interfaces 128B may be associated with one or more other computing systems (e.g., a server computing system or third party computing system). The user interfaces 128B can include a viewfinder interface, a search interface, a generative model interface, a social media interface, or a media content gallery interface.

The controller 110B may include or receive data from one or more load sensors 104B. The one or more sensors 104B may be housed in a housing component that houses the one or more processors 118B, the memory 120B, or one or more hardware components, which may store, or cause to perform, one or more software packets.

It is noted that, although not pictured, a suitable power source (e.g., battery, AC voltage port, etc.) could be provided in electrical communication with secondary scale 100B to electrically power the same (e.g., as is generally understood).

In some embodiments, controller 110B includes a communications interface 130B such that secondary scale 100B can connect to and communicate over one or more networks (e.g., network 150) with one or more network nodes, such as secondary scale 100B. Communications interface 130B can be an onboard component of controller 110B or it can be a separate, off board component. In some implementations, the communications interface 130B may include for example, one or more of a communications controller, receiver, transceiver, transmitter, port, conductors, software and/or hardware for communicating data/information. Controller 110B can also include one or more transmitting, receiving, or transceiving components for transmitting/receiving communications with other devices communicatively coupled with secondary scale 100B. Additionally or alternatively, one or more transmitting, receiving, or transceiving components can be located off board controller 110B.

In some embodiments, the controller 110B may not include a user interface. Instead, the controller 110B may communicate, via the communications interface 130B, data to be displayed to the controller 110A. Upon receiving the data from the controller 110B, the controller 110A may then display the data on its user interface 128A (e.g., display). This provides a power-saving advantage where the secondary scale 100B does not need to implement a display that consumes additional power.

In certain embodiments, controller 110B includes an angle sensor 132B that is generally configured to detect a plurality of angle readings. Angle sensor 132B can be an onboard component of controller 110B or it can be a separate, off board component (e.g., attached to a platter 102 or base frame 112 (FIGS. 1 and 2)). As would be understood, the angle sensor 132B may include a microprocessor that performs the calculations specific to the measurement of position or movement with the calculation results being used by controller 110B.

As noted above, angle sensor 132B may detect a plurality of angle readings. For instance, multiple angle readings may be detected simultaneously to track multiple (e.g., mutually orthogonal) axes of the secondary scale 100B, such as an X-axis, Y-axis, and Z-axis. For instance, the axes may be detected or tracked relative to gravity. Optionally, an angle sensor 132B may be or include an accelerometer, which measures, at least in part, the effects of gravity (e.g., as an acceleration component), such as acceleration along one or more predetermined directions. Additionally or alternatively, an angle sensor 132B may be or include a gyroscope, which measures rotational positioning (e.g., as a rotation component).

An angle sensor 132B in accordance with the present disclosure can be mounted on or within the secondary scale 100B, as required to sense movement or position of secondary scale 100B relative to the gravity or a supporting surface. Optionally, angle sensor 132B may include at least one gyroscope or at least one accelerometer. The angle sensor 132B, for example, may be a printed circuit board which includes the gyroscope and accelerometer thereon.

In additional or alternative embodiments, the controller 110B includes location module 134B that is generally configured to detect a geographic location of secondary scale 100B. Location module 134B can be an onboard component of controller 110B or it can be a separate, off board component (e.g., attached to a platter 102 or base frame 112 (FIGS. 1 and 2)). As one example, location module 134B can be a Global Positioning System (GPS) and can receive location or position information from a plurality of GPS satellites. In turn, location module 134B can include various hardware and software known in the art for receiving data indicative of a geographic location of secondary scale 100B. For instance, location module 134B can include a GPS receiver. In some embodiments, location module 134B can automatically obtain data indicative of the geographic location of secondary scale 100B when secondary scale 100B is connected to network 150 (e.g., in response to the same). In other embodiments, location module 134B can obtain data indicative of the geographic location of secondary scale 100B when secondary scale 100B is connected to appliance network 150 and upon a user input.

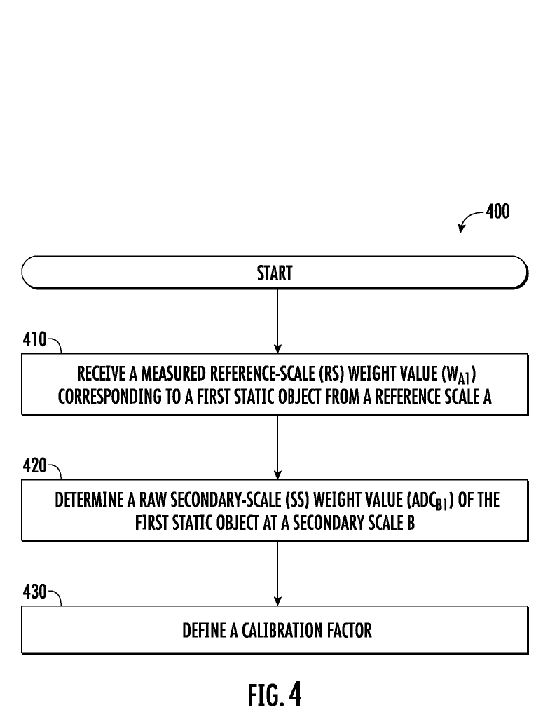

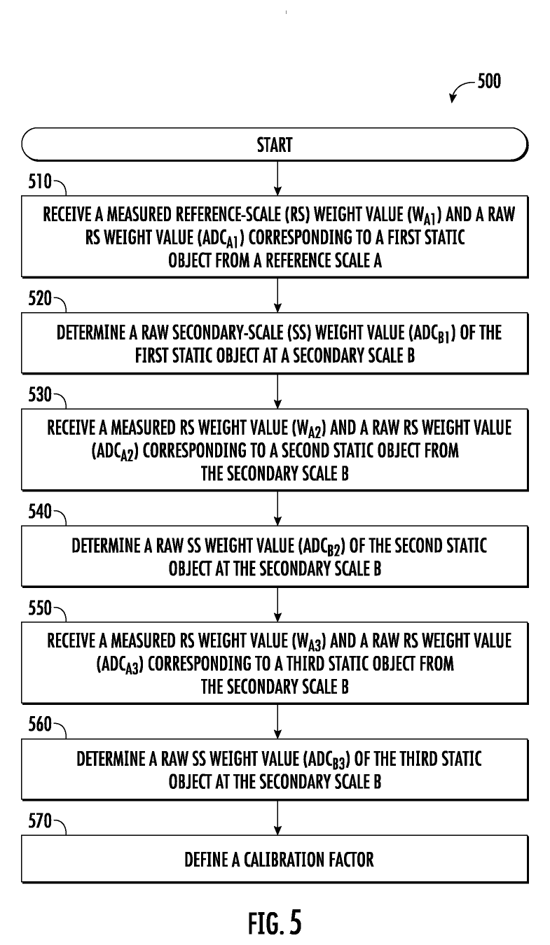

Turning now to FIGS. 4 and 5, the present disclosure may further be directed to methods (e.g., method 400 or 500) of operating a scale, such as scale 100 or secondary scale 100B. In exemplary embodiments, the controller 110, 110A, or 110B may be operable to perform various steps of a method in accordance with the present disclosure.

The methods (e.g., 400 or 500) may occur as, or as part of, a scale operation or calibration of a secondary scale. In particular, the methods (e.g., 400 or 500) disclosed herein may advantageously facilitate calibration of the scale (e.g., without requiring specialized or calibrated weights). Additionally or alternatively, the methods (e.g., 400 or 500) disclosed herein may be able to calibrate a scale across multiple weights or a range of weights.

It is noted that the order of steps within methods 400 and 500 are for illustrative purposes. Moreover, none of the methods 400 and 500 are mutually exclusive. In other words, methods within the present disclosure may include one or more of methods 400 and 500. All may be adopted or characterized as being fulfilled in a common operation. Except as otherwise indicated, one or more steps in the below method 400 and 500 may be changed, rearranged, performed in a different order, or otherwise modified without deviating from the scope of the present disclosure.

Turning especially to FIG. 4, at 410, the method 400 includes receiving a measured reference-scale (RS) weight value (W_{A1}) corresponding to a first static object from a reference scale A. For instance, following or in response to the first static object being placed on the platter of the reference scale A, the reference scale A may determine the weight value (W_{A1}) corresponding to the first static object. In some embodiments, 410 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a tare action or powering on the reference scale (e.g., from an unpowered, sleep, or otherwise inactive state), such as to determine a baseline or static weight on the platter. In additional or alternative embodiments, the weight signals are received following or in response to a user confirmation (e.g., received at the inputs) that the first static object has been placed on the reference scale A. Additionally or alternatively, 410 may include determining a set number of consecutive weight signals generally match or indicate the same mass (e.g., within a predetermined tolerance). Optionally, a predetermined correction number or factor may be applied to a raw sensor load value corresponding to the weight signals from the load sensor of the reference scale A to generate the weight value (W_{A1}).

As noted above, the reference scale and the secondary scale may be operatively connected, such as in a wireless connection. In turn, the weight value (W_{A1}) may be transmitted to and received by the secondary scale via one or more networks.

At 420, the method 400 includes determining a raw secondary-scale (SS) weight value (ADC_{B1}) of the first static object at a secondary scale B. For instance, following or in response to the first static object being placed on the platter of the secondary scale B, the secondary scale B may determine a steady signal or weight value (ADC_{B1}) is received from the load sensor of the secondary scale. In some embodiments, 420 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a tare action or powering on the reference scale (e.g., from an unpowered, sleep, or otherwise inactive state), such as to determine a baseline or static weight value (ADC_{B1}) on the platter. In additional or alternative embodiments, the weight signals are received following or in response to a user confirmation (e.g., received at the inputs) that the first static object has been placed on the secondary scale B. As would be understood, the weight signals may each correspond to and be used to calculate a raw weight value. Additionally or alternatively, 420 may include determining a set number of consecutive weight signals generally match or indicate the same mass or weight value (ADC_{B1}) (e.g., within a predetermined tolerance).

At 430, the method 400 includes defining a calibration factor for the secondary scale. In particular, the raw SS weight value (ADC_{B1}) may be compared to the measured RS weight value (W_{A1}). A SS delta (e.g., difference in the values ADC_{B1}and W_{A1}) may then be determined based on the comparison. Moreover, based on the SS delta, the calibration factor may be calculated. As an example, the calibration factor may be set as a fixed correction value (e.g., the SS delta). As another example, the calibration factor may be set as a variable correction function (e.g., percentage) according to the SS delta and a predetermined function template, as would be understood.

Following 430, the method 400 may further include confirming calibration at the secondary scale. Such a confirmation may include again receiving a plurality of weight signals from the corresponding load sensor (e.g., preceding or following one or more signal filtration actions, as would be understood) while the first static object rests on the platter of the secondary scale. As would be understood, the first static object may be required to be removed from the platter following 430 and again returned to the platter for (e.g., prior to completion of) the confirmation. Moreover, a user may be instructed to remove and return the first static object (e.g., using one or more messages at the electronic display of the secondary scale). A new determination may be made that a steady signal or weight value (ADC_{B2}) is received from the load sensor of the secondary scale. The calibration factor may then be applied to the steady signal or weight value (ADC_{B2}) to generate a weight value (W_{B2}) corresponding to the first static object. The weight value (W_{B2}) may be compared to the weight value (W_{A1}). If the weight value (W_{B2}) is determined to be substantially equal to the weight value (W_{A1}), the calibration factor may be validated and stored within the secondary scale. In other words, in response to a determination that the weight value (W_{B2}) is substantially equal to the weight value (W_{A1}), the calibration factor may be confirmed and stored for subsequent measurements. Optionally, a confirmation message may be displayed (e.g., at the electronic display). By contrast, if the weight value (W_{B2}) is not determined to be substantially equal to the weight value (W_{A1}), the calibration factor may be discarded. In other words, in response to a determination that the weight value (W_{B2}) is not substantially equal to the weight value (W_{A1})—or an otherwise failed determination—the calibration factor may not be stored for subsequent measurements. Optionally, an error message may be displayed (e.g., at the electronic display), or the secondary scale may otherwise instruct a user to repeat calibration.

Separately from or in addition to confirmation of the calibration factor, after being generated, the calibration factor may be stored within the secondary scale and applied to future raw SS values detected at the secondary scale to output a measured SS value (e.g., to be displayed at the electronic display of the secondary scale), such as until the calibration steps are repeated to generate a new calibration factor.

Turning especially to FIG. 5, at 510, the method 500 includes receiving a measured reference-scale (RS) weight value (W_{A1}) and a raw RS weight value (ADC_{A1}) corresponding to a first static object from a reference scale A. For instance, following or in response to the first static object being placed on the platter of the reference scale A, the reference scale A may determine first the raw RS weight value (ADC_{A1}) and then the measured weight value (W_{A1}) corresponding to the first static object. In some embodiments, 510 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a tare action or powering on the reference scale (e.g., from an unpowered, sleep, or otherwise inactive state), such as to determine a baseline or static weight on the platter. As would be understood, the weight signals may each correspond to and be used to calculate a raw weight value. Additionally or alternatively, 510 may include determining a set number of consecutive weight signals generally match or indicate the same mass or weight value (ADC_{A1}) (e.g., within a predetermined tolerance). Optionally, a predetermined correction number or factor may be applied to the raw weight value (ADC_{A1}) to generate the weight value (W_{A1}).

As noted above, the reference scale and the secondary scale may be operatively connected, such as in a wireless connection. In turn, the raw RS weight value (ADC_{A1}) or the weight value (W_{A1}) may be transmitted to and received by the secondary scale via one or more networks.

At 520, the method 500 includes determining a raw secondary-scale (SS) weight value (ADC_{B1}) of the first static object at a secondary scale B. For instance, following or in response to the first static object being placed on the platter of the secondary scale B, the secondary scale B may determine a steady signal or weight value (ADC_{B1}) is received from the load sensor of the secondary scale. In some embodiments, 520 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a tare action or powering on the reference scale (e.g., from an unpowered, sleep, or otherwise inactive state), such as to determine a baseline or static weight value (ADC_{B1}) on the platter. In additional or alternative embodiments, the weight signals are received following or in response to a user confirmation (e.g., received at the inputs) that the first static object has been placed on the secondary scale B. As would be understood, the weight signals may each correspond to and be used to calculate a raw weight value. Additionally or alternatively, 520 may include determining a set number of consecutive weight signals generally match or indicate the same mass or weight value (ADC_{B1}) (e.g., within a predetermined tolerance).

At 530, the method 500 includes receiving a measured RS weight value (W_{A2}) and a raw RS weight value (ADC_{A2}) corresponding to a second static object (e.g., having a second mass that is higher than a first mass of the first static object) from the reference scale A. For instance, following or in response to the second static object being placed on the platter of the reference scale A, the reference scale A may determine first the raw RS weight value (ADC_{A2}) and then the measured weight value (W_{A2}) corresponding to the second static object. In some embodiments, 530 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a user confirmation (e.g., received at the inputs) that the second static object has been placed on the reference scale A. As would be understood, the weight signals may each correspond to and be used to calculate a raw weight value. Additionally or alternatively, 530 may include determining a set number of consecutive weight signals generally match or indicate the same mass or weight value (ADC_{A2}) (e.g., within a predetermined tolerance). Optionally, a predetermined correction number or factor (e.g., matching or different from the predetermined correction number or factor of 510) may be applied to the raw weight value (ADC_{A2}) to generate the weight value (W_{A2}). Subsequently, the raw RS weight value (ADC_{A2}) or the weight value (W_{A2}) may be transmitted to and received by the secondary scale via one or more networks.

At 540, the method 500 includes determining a raw SS weight value (ADC_{B2}) of the second static object at the secondary scale B. For instance, following or in response to the second static object being placed on the platter of the secondary scale B, the secondary scale B may determine a steady signal or weight value (ADC_{B2}) is received from the load sensor of the secondary scale. In some embodiments, 540 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a user confirmation (e.g., received at the inputs) that the second static object has been placed on the secondary scale B. As would be understood, the weight signals may each correspond to and be used to calculate a raw weight value. Additionally or alternatively, 540 may include determining a set number of consecutive weight signals generally match or indicate the same mass or weight value (ADC_{B2}) (e.g., within a predetermined tolerance).

At 550, the method 500 includes receiving a measured RS weight value (W_{A3}) and a raw RS weight value (ADC_{A3}) corresponding to a third static object (e.g., having a third mass that is higher than the second mass of the second static object) from the reference scale A. For instance, following or in response to the third static object being placed on the platter of the reference scale A, the reference scale A may determine first the raw RS weight value (ADC_{A3}) and then the measured weight value (W_{A3}) corresponding to the third static object. In some embodiments, 530 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a user confirmation (e.g., received at the inputs) that the third static object has been placed on the reference scale A. As would be understood, the weight signals may each correspond to and be used to calculate a raw weight value. Additionally or alternatively, 550 may include determining a set number of consecutive weight signals generally match or indicate the same mass or weight value (ADC_{A3}) (e.g., within a predetermined tolerance). Optionally, a predetermined correction number or factor (e.g., matching or different from the predetermined correction number or factor of 510 or 530) may be applied to the raw weight value (ADC_{A3}) to generate the weight value (W_{A3}). Subsequently, the raw RS weight value (ADC_{A3}) or the weight value (W_{A3}) may be transmitted to and received by the secondary scale via one or more networks.

At 560, the method 500 includes determining a raw SS weight value (ADC_{B2}) of the third static object at the secondary scale B. For instance, following or in response to the third static object being placed on the platter of the secondary scale B, the secondary scale B may determine a steady signal or weight value (ADC_{B3}) is received from the load sensor of the secondary scale. In some embodiments, 560 includes receiving a plurality of weight signals from the corresponding load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the weight signals are received following or in response to a user confirmation (e.g., received at the inputs) that the third static object has been placed on the secondary scale B. As would be understood, the weight signals may each correspond to and be used to calculate a raw weight value. Additionally or alternatively, 550 may include determining a set number of consecutive weight signals generally match or indicate the same mass or weight value (ADC_{B3}) (e.g., within a predetermined tolerance).

At 570, the method 400 includes defining a calibration factor based on one or more data values. For instance, the calibration factor may be based on some or all of the above-mentioned values, such as the measured RS weight values (W_{A1}, W_{A2}), the raw RS weight values (ADC_{A1}, ADC_{A2}), and the raw SS weight values (ADC_{B1}, ADC_{B2}), which may be used to determine a reference-correction factor—the reference-correction factor being then set as or as part of the defined calibration factor. Further, the reference-correction factor may be based on all of the measured RS weight values (W_{A1}, W_{A2}, W_{A3}), the raw RS weight values (ADC_{A1}, ADC_{A2}, ADC_{A3}), and the raw SS weight values (ADC_{B1}, ADC_{B2}, ADC_{B3}).

In some embodiments, determining the reference-correction factor may include determining a calibration curve using one or more of the above-mentioned values (e.g., measured RS weight values (W_{A1}, W_{A2}, W_{A3}), the raw RS weight values (ADC_{A1}, ADC_{A2}, ADC_{A3}), and the raw SS weight values (ADC_{B1}, ADC_{B2}, ADC_{B3})). As an example, a linear calibration scale may be determined. For instance, using a collected database of the measured RS weight values (W_{A1}, W_{A2}, W_{A3}), the raw RS weight values (ADC_{A1}, ADC_{A2}, ADC_{A3}), and the raw SS weight values (ADC_{B1}, ADC_{B2}, ADC_{B3}), a linear formula (e.g., following a linear line fit for the data) may be generated such that a raw SS weight value may be interpolated through the linear formula to generate a new measured SS weight value. In other words, a discrete raw SS weight value (ADC_{Bn}) (e.g., differing from ADC_{B1}, ADC_{B2}, and ADC_{B3}) may be input or applied to the linear calibration scale to calculate an output in the form of a corresponding measured SS weight value (W_{Bn}). In some embodiments, a nonlinear formula such as a polynomial curve fit may be used to determine the reference-correction factor.

Separate from or in addition to the reference-correction factor, the calibration factor may include or be provided as a geo-correction factor. Generally, the geo-correction factor may account for variations in gravitational force at various geographical locations. In some such embodiments, the method 500 further includes determining a geolocation at the secondary scale. For instance, a location module on the secondary scale (or another remote device connected to the secondary scale) may be used to detect a geographic location (e.g., as described above). Additionally or alternatively, a user may input or select a geographic location (e.g., using the user interface of the secondary scale or a connected remote device). Subsequently, the geo-location factor may be selected (e.g., according to a predetermined or programmed look-up table or chart) based on the determined geolocation (e.g., used as an input). In some such embodiments, the geo-correction factor is output as a calibration coefficient for adjusting measured weight values according to a determined deviation from a gravitational baseline.

Further separate from or in addition to the reference-correction factor, the calibration factor may include or be provided as an angle-correction factor. Generally, the angle-correction factor may account for variations in gravitational force caused by variations in the orientation of the scale (e.g., variations from a directional baseline, such as vertical or horizontal plane defined relative to gravity or the reference scale). In some such embodiments, the method 500 further includes determining a tilt angle at the secondary scale. For instance, an angle sensor on the secondary scale (or another remote device connected to the secondary scale) may be used to detect an angle of tilt for the secondary scale (e.g., as described above). Optionally, a reference tilt angle may be determined at the reference scale. Subsequently, the angle-correction factor may be selected (e.g., according to a predetermined or programmed look-up table or chart) based on the determined tilt angle (e.g., used as an input). In some such embodiments, the angle-correction factor is output as a calibration coefficient for adjusting measured weight values according to a determined deviation from a directional (e.g., vertical or horizontal) baseline.

After being generated, the calibration factor may be stored within the secondary scale and applied to future raw SS values detected at the secondary scale to output a measured SS value (e.g., to be displayed at the electronic display of the secondary scale), such as until the calibration steps are repeated to generate a new calibration factor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a scale, the method comprising:
receiving a measured reference-scale (RS) weight value (W_{A1}) and a raw RS weight value (ADC_{A1}) corresponding to a first static object from a reference scale;
determining a raw secondary-scale (SS) weight value (ADC_{B1}) of the first static object at a secondary scale;
receiving a measured RS weight value (W_{A2}) and a raw RS weight value (ADC_{A2}) corresponding to a second static object from the secondary scale;
determining a raw SS weight value (ADC_{B2}) of the second static object at the secondary scale; and
defining a calibration factor, defining a calibration factor comprising determining a reference-correction factor based on the measured RS weight values (W_{A1} W_{A2}), the raw RS weight values (ADC_{A1} ADC_{A2}), and the raw SS weight values (ADC_{B1} ADC_{B2}).

2. The method of claim 1, wherein the secondary scale is wirelessly connected to the reference scale.

3. The method of claim 1, wherein the first static object has a first mass, wherein the second static object has a second mass, and
wherein the second mass is greater than the first mass.

4. The method of claim 1, further comprising:
receiving a measured RS weight value (W_{A3}) and a raw RS weight value (ADC_{A3}) corresponding to a third static object from the reference scale.

5. The method of claim 4, further comprising:
determining a raw SS weight value (ADC_{B3}) of the third static object at the secondary scale.

6. The method of claim 5, wherein the reference-correction factor is based on the measured RS weight values (W_{A1} W_{A2} W_{A3}), the raw RS weight values (ADC_{A1} ADC_{A2}ADC_{A3}), and the raw SS weight values (ADC_{B1} ADC_{B2} ADC_{B3}).

7. The method of claim 6, wherein determining the reference-correction factor comprises
determining a linear calibration scale using the measured RS weight values (W_{A1} W_{A2} W_{A3}), the raw RS weight values (ADC_{A1} ADC_{A2} ADC_{A3}), and the raw SS weight values (ADC_{B1} ADC_{B2} ADC_{B3}).

8. The method of claim 1, further comprising:
determining a geolocation at the secondary scale,
wherein defining the calibration factor further comprises selecting a geo-correction factor based on the determined geolocation.

9. The method of claim 1, further comprising:
determining a tilt angle at the reference scale,
wherein defining the calibration factor further comprises selecting an angle-correction factor based on the determined tilt angle.

10. The method of claim 4, wherein the first static object has a first mass,
wherein the second static object has a second mass,
wherein the third static object has a third mass,
wherein the second mass is greater than the first mass, and
wherein the third mass is greater than the second mass.

11. A secondary scale comprising:
a platter to receive a scale load thereon;
a load sensor mounted below the platter in mechanical connection therewith to detect a mass of the scale load;
an electronic display attached to the platter; and
a controller operably connected to the load sensor and the electronic display, the controller being configured to perform operations comprising:
receiving a measured reference-scale (RS) weight value (W_{A1}) and a raw RS weight value (ADC_{A1}) corresponding to a first static object from a reference scale,
determining a raw secondary-scale (SS) weight value (ADC_{B1}) of the first static object at the secondary scale,
receiving a measured RS weight value (W_{A2}) and a raw RS weight value (ADC_{A2}) corresponding to a second static object from the secondary scale,
determining a raw SS weight value (ADC_{B2}) of the second static object at the secondary scale, and
defining a calibration factor, defining a calibration factor comprising determining a reference-correction factor based on the measured RS weight values (W_{A1} W_{A2}), the raw RS weight values (ADC_{A1} ADC_{A2}), and the raw SS weight values (ADC_{B1} ADC_{B2}).

12. The secondary scale of claim 11, wherein the secondary scale is wirelessly connected to the reference scale.

13. The secondary scale of claim 11, wherein the first static object has a first mass, wherein the second static object has a second mass, and
wherein the second mass is greater than the first mass.

14. The secondary scale of claim 11, wherein the operations further comprise
receive a measured RS weight value (W_{A3}) and a raw RS weight value (ADC_{A3}) corresponding to a third static object from the reference scale.

15. The secondary scale of claim 14, wherein the operations further comprise
determining a raw SS weight value (ADC_{B3}) of the third static object at the secondary scale.

16. The secondary scale of claim 15, wherein the reference-correction factor is based on the measured RS weight values (W_{A1} W_{A2} W_{A3}), the raw RS weight values (ADC_{A1} ADC_{A2} ADC_{A3}), and the raw SS weight values (ADC_{B1} ADC_{B2} ADC_{B3}).

17. The secondary scale of claim 16, wherein determining the reference-correction factor comprises
determining a linear calibration scale using the measured RS weight values (W_{A1} W_{A2} W_{A3}), the raw RS weight values (ADC_{A1} ADC_{A2} ADC_{A3}), and the raw SS weight values (ADC_{B1} ADC_{B2} ADC_{B3}).

18. The secondary scale of claim 11, wherein the operations further comprise
determining a geolocation at the secondary scale,
wherein defining the calibration factor further comprises selecting a geo-correction factor based on the determined geolocation.

19. The secondary scale of claim 11, wherein the operations further comprise
determining a tilt angle at the reference scale wherein defining the calibration factor further comprises selecting an angle-correction factor based on the determined tilt angle.

20. The secondary scale of claim 14, wherein the first static object has a first mass,
wherein the second static object has a second mass,
wherein the third static object has a third mass,
wherein the second mass is greater than the first mass, and
wherein the third mass is greater than the second mass.
